(19) United States
(12) Patent Application Publication
(10) Pub. No.: US 2014/0160104 A1
(43) Pub. Date: Jun. 12, 2014

(54) DISPLAY DRIVING METHOD AND ASSOCIATED DRIVING CIRCUIT FOR DISPLAY APPARATUS

(71) Applicant: NOVATEK MICROELECTRONICS CORP., Hsin-Chu (TW)

(72) Inventors: Ying-Zu Lin, Taichung City (TW); Chia-Wei Su, Hsinchu City (TW); Shun-Hsun Yang, Hsinchu City (TW); Chia-Hsun Kuo, Hsinchu City (TW); Li-Tang Lin, Hsinchu City (TW)

(73) Assignee: NOVATEK MICROELECTRONICS CORP., Hsin-Chu (TW)

(21) Appl. No.: 13/964,120

(22) Filed: Aug. 12, 2013

(30) Foreign Application Priority Data
Dec. 11, 2012 (TW) 101146699

(51) Int. Cl. G09G 3/36

(52) U.S. Cl. CPC G09G 3/3696
USPC 345/212; 345/87

(57) ABSTRACT

A display driving method and an associated driving circuit are provided, where the display driving method includes: checking relationships between two voltage levels respectively represented by two continuously received digital codes received by a specific digital code input terminal and a first predetermined threshold, and preferably further checking a relationship between at least one voltage level represented by at least one digital code of the two continuously received digital codes and a first predetermined zone, in order to determine whether to pre-charge a specific set of display cells within a plurality of sets of display cells, the specific set corresponding to the specific digital code input terminal; when it is determined to pre-charge the specific set of display cells, temporarily conducting a pre-charging voltage generator to the specific set of display cells to pre-charge the specific set of display cells.

### BACKGROUND OF THE INVENTION

1. Field of the Invention

The disclosed embodiments of the present invention relate to a driver of a liquid crystal display module (LCM), and more particularly, to a display driving method and an associated driving circuit.

2. Description of the Prior Art

When an amplifier array of a conventional driving circuit drives a capacitive load, the conventional driving circuit needs to provide sufficient charges in order to charge an equivalent capacitance of the capacitive load to a required voltage level, which results in huge power consumption. To solve the problem, charge reuse methods are provided in the related art. The charge reuse methods, however, usually cause side effects, such as too many control phases needed and slower response speed. Thus, a novel driving method is needed to mitigate the aforementioned side effects and further enhance efficiency of a driving circuit.

### SUMMARY OF THE INVENTION

It is therefore one objective of the present invention to provide a display driving method and a related driving circuit to solve the above problems.

It is therefore another objective of the present invention to provide a display driving method and a related driving circuit to mitigate the aforementioned side effects and further enhance overall efficiency of a display apparatus (or an electronic apparatus having a display module).

According to a preferred embodiment of the present invention, an exemplary display driving method is disclosed. The exemplary display driving method is applied to a driving circuit of a display apparatus. The driving circuit includes a plurality of digital code input terminals corresponding to a plurality of sets of display cells of the display. A digital code received by each digital code input terminal represents a predetermined gray-level of a corresponding set of display cells within the sets of display cells. The exemplary display driving method includes the following steps: checking relationships between two voltage levels respectively represented by two continuously received digital codes received by a specific digital code input terminal and a first predetermined threshold in order to determine whether to pre-charge a specific set of display cells within the sets of display cells that corresponds to the specific digital code input terminal, wherein the two voltage levels respectively represent voltage levels applied to the specific set of display cells by the driving circuit at different time points according to indication of the two digital codes; and when it is determined to pre-charge the specific set of display cells, temporarily conducting a first pre-charging voltage generator in the driving circuit to the specific set of display cells to pre-charge the specific set of display cells, wherein the first pre-charging voltage generator is arranged for outputting a first pre-charging voltage for pre-charging.

Besides the above display driving method, an associated driving circuit of a display apparatus is also provided correspondingly. The exemplary driving circuit of the display apparatus includes a plurality of driving modules, a first pre-charging voltage generator, a first set of switches and a switch control circuit. The driving modules include a plurality of digital code input terminals and a plurality of output terminals. The first set of switches are electrically connected between the first pre-charging voltage generator and the output terminals, respectively. The switch control circuit is coupled to the digital code input terminals and electrically connected to the first set of switches. The driving modules are arranged for driving a plurality of sets of display cells of the display apparatus, wherein the output terminals are electrically connected to the sets of display cells, the digital code input terminals correspond to the sets of display cells, respectively, and a digital code received by each digital code input terminal represents a predetermined gray-level of a corresponding set of display cells within the sets of display cells. The first pre-charging voltage generator is arranged for outputting a first pre-charging voltage for pre-charging. The first set of switches is arranged to perform signal switching, wherein each switch in the first set of switches is utilized to selectively conduct the first pre-charging voltage generator to a corresponding output terminal in the output terminals. The switch control circuit is arranged for checking relationships between two voltage levels respectively represented by two continuously received digital codes received by a specific digital code input terminal and a first predetermined threshold to determine whether to pre-charge a specific set of display cells within the sets of display cells that corresponds to the specific digital code input terminal, wherein the two voltage levels respectively represent voltage levels applied to the specific set of display cells by the driving circuit at different time points according to indication of the two digital codes. When it is determined to pre-charge the specific set of display cells, the switch control circuit utilizes a switch corresponding to the specific digital code input terminal in the first set of switches to temporarily conduct the first pre-charging voltage generator to the specific set of display cells to pre-charge the specific set of display cells.

It is an advantage of the present invention that, compared to a conventional driving circuit, the proposed display driving method and an associated driving circuit can mitigate the aforementioned side effects while enhancing overall efficiency of the driving circuit.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an exemplary driving circuit of a display apparatus according to a first embodiment of the present invention.

FIG. 2 is a flowchart illustrating an exemplary display driving method according to an embodiment of the present invention.

FIG. 3 illustrates a timing diagram involved in the display driving method shown in FIG. 2 according to an embodiment of the present invention.

FIG. 4 illustrates a timing diagram involved in the display driving method shown in FIG. 2 according to another embodiment of the present invention.

FIG. 5 illustrates a timing diagram involved in the display driving method shown in FIG. 2 according to another embodiment of the present invention.

FIG. 6 illustrates a timing diagram involved in the display driving method shown in FIG. 2 according to another embodiment of the present invention.

FIG. 7 illustrates a timing diagram involved in the display driving method shown in FIG. 2 according to another embodiment of the present invention.

FIG. 8 illustrates a timing diagram involved in the display driving method shown in FIG. 2 according to another embodiment of the present invention.

FIG. 9 illustrates a timing diagram involved in the display driving method shown in FIG. 2 according to another embodiment of the present invention.

FIG. 10 is a diagram illustrating an exemplary driving circuit of a display apparatus according to a second embodiment of the present invention.

### DETAILED DESCRIPTION

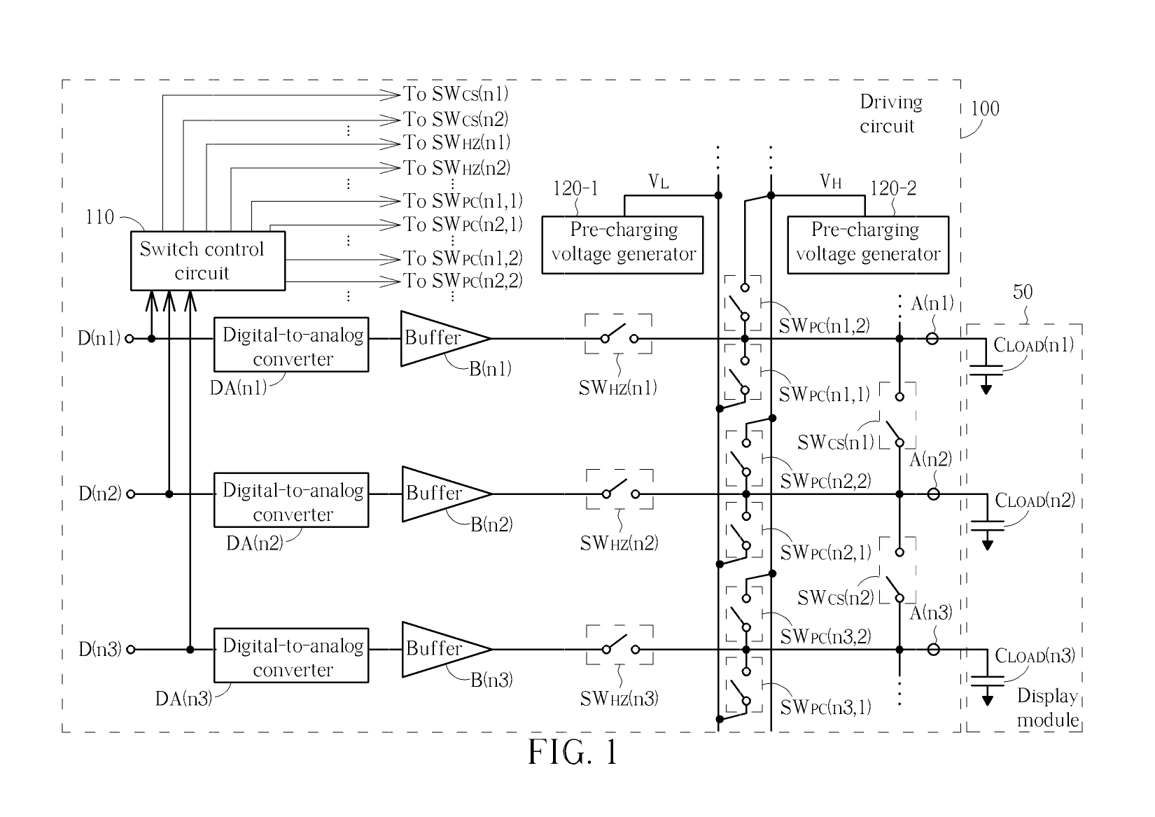

FIG. 1 is a diagram illustrating an exemplary driving circuit of a display apparatus according to a first embodiment of the present invention. By way of example, but not limitation, the display apparatus may be a liquid crystal display module (LCM). This is for illustrative purposes only, and is not meant to be a limitation of the present invention. According to variations of the embodiment, the display apparatus may also be a display module implemented by a non liquid crystal display technology as long as implementations of the present invention are not hindered. To facilitate understanding of technical features of the present invention, FIG. 1 further illustrates equivalent capacitors (e.g. load capacitors C_{LOAD}(n1), C_{LOAD}(n2), C_{LOAD}(n3)) of a portion of display cells in a display module 50 (e.g. the aforementioned LCM) driven by the driving circuit 100, wherein the load capacitors C_{LOAD}(n1), C_{LOAD}(n2), C_{LOAD}(n3) may be regarded as capacitive loads. For example, each load capacitor C_{LOAD}(n) of the load capacitors C_{LOAD}(n1), C_{LOAD}(n2), C_{LOAD}(n3) may be an equivalent capacitor of n^{th}-row display cells of the display module 50 (e.g. the LCM), and transistors of the n^{th}-row display cells are coupled in series through gates and drains. Hence, regarding the driving circuit 100, the load capacitors C_{LOAD}(n1), C_{LOAD}(n2), C_{LOAD}(n3) may be represented by an n1^{th}-row display cell, an n2^{th}-row display cell, an n3^{th}-row display cell in the display module 50, respectively.

As shown in FIG. 1, the driving circuit 100 may include a plurality of driving modules respectively corresponding to the load capacitors C_{LOAD}(n1), C_{LOAD}(n2), C_{LOAD}(n3). For example, the driving modules may have a driving module including a digital-to-analog converter (DAC) DA(n1), a buffer B(n1) and a switch SW_{HZ}(n1), a driving module including a DAC DA(n2), a buffer B(n2) and a switch SW_{HZ}(n2), a driving module including a DAC DA(n3), a buffer B(n3) and a switch SW_{HZ}(n3), and so on. In this embodiment, the driving modules include a plurality of digital code input terminals D(n1), D(n2), D(n3), respectively, and include a plurality of output terminals A(n1), A(n2), A(n3), respectively. The output terminals A(n1), A(n2), A(n3) are electrically connected to a plurality of sets of display cells represented by the load capacitors C_{LOAD}(n1), C_{LOAD}(n2), C_{LOAD}(n3). The digital code input terminals D(n1), D(n2), D(n3) correspond to the sets of display cells, respectively. A digital code received by each digital code input terminal D(n) of the digital code input terminals D(n1), D(n2), D(n3) represents a predetermined gray-level of a corresponding set of display cells within the sets of display cells (i.e. a set of display cells represented by the load capacitor C_{LOAD}(n)).

The driving circuit 100 further includes: at least one pre-charging voltage generator such as pre-charging voltage generators 120-1 and 120-2, wherein the number of the at least one pre-charging voltage generator may be varied in different embodiments/variations; at least one set of switches such as a first set of switches {SW_{PC}(n1,1), SW_{PC}(n2,1), SW_{PC}(n3,1)} and a second set of switches {SW_{PC}(n1,2), SW_{PC}(n2,2), SW_{PC}(n3,2)}, wherein the first set of switches {SW_{PC}(n1,1), SW_{PC}(n2,1), SW_{PC}(n3,1)} are electrically connected between the pre-charging voltage generator 120-1 and the output terminals A(n1), A(n2), A(n3), respectively, the second set of switches {SW_{PC}(n1,2), SW_{PC}(n2,2), SW_{PC}(n3,2)} are electrically connected between the pre-charging voltage generator 120-2 and the output terminals A(n1), A(n2), A(n3), respectively, and the number of the at least one set of switches corresponds to the number of the at least one pre-charging voltage generator; another set of switches {SW_{CS}(n1), SW_{CS}(n2)}, whose connection in this embodiment shown in FIG. 1 is for illustrative purposes only and is not meant to be a limitation of the present invention, wherein each switch SW_{CS}(n) of the another set of switches {SW_{CS}(n1), SW_{CS}(n2)} is electrically connected between two output terminals (for charge sharing) of the output terminals A(n1), A(n2), A(n3); and a switch control circuit 110, coupled to the digital code input terminals D(n1), D(n2), D(n3) and electrically connected to the first set of switches {SW_{PC}(n1,1), SW_{PC}(n2,1), SW_{PC}(n3,1)}, the second set of switches {SW_{PC}(n1,2), SW_{PC}(n2,2), SW_{PC}(n3,2)}, the another set of switches {SW_{CS}(n1), SW_{CS}(n2)} and the aforementioned switches {SW_{HZ}(n1), SW_{HZ}(n2), SW_{HZ}(n3)}.

Please note that, as charges may include positive charges and negative charges, the word “pre-charging” may further encompass “pre-discharging”. For simplicity, the following description will use “pre-charging” rather than “pre-discharging” which corresponds to certain cases. Additionally, according to this embodiment or variations thereof, indices n1, n2, n3 may depend on design requirements of the driving circuit 100. For example, the indices n1, n2, n3 may represent a series of regularly arranged integers such as 1, 2, 3. In another example, as long as implementations of the present invention are not hindered, indices n1, n2, n3 may represent a series of arbitrarily arranged integers.

In practice, the buffers B(n1), B(n2), B(n3) may be implemented by an amplifier array, and the at least one set of switches (e.g. the first set of switches {SW_{PC}(n1,1), SW_{PC}(n2,1), SW_{PC}(n3,1)} and the second set of switches {SW_{PC}(n1,2), SW_{PC}(n2,2), SW_{PC}(n3,2)}), the another set of switches {SW_{CS}(n1), SW_{CS}(n2)} and the switches {SW_{HZ}(n1), SW_{HZ}(n2), SW_{HZ}(n3)} may be implemented by metal oxide semiconductor filed effect transistors (MOSFETs). In addition, the switch control circuit 110 may be implemented by logic circuit(s), wherein the logic circuit(s) may include a plurality of logic gates and related control circuit(s). The at least one pre-charging voltage generator (e.g. the pre-charging voltage generators 120-1 and 120-2) may be implemented by power management circuit(s) (or voltage generation modules within power management circuit(s)), respectively. This is for illustrative purposes only, and is not meant to be a limitation of the present invention. According to variations of this embodiment, the at least one pre-charging voltage generator (e.g. the pre-charging voltage generators 120-1 and 120-2) may also be implemented by capacitor(s).

Based on the architecture shown in FIG. 1, the driving circuit 100 may use the driving modules to drive display cells of the display apparatus, especially the sets of display cells represented by the load capacitors C_{LOAD}(n1), C_{LOAD}(n2), C_{LOAD}(n3). Under the control of the switch control circuit 110, the driving circuit 100 may also utilize switches {SW_{HZ}(n1), SW_{HZ}(n2), SW_{HZ}(n3)} respectively to make the driving modules temporarily stop driving the sets of display cells, wherein the driving circuit 100 may utilize the DACs DA(n1), DA(n2), DA(n3) to perform digital-to-analog conversions, respectively, and utilize the buffers B(n1), B(n2), B(n3) to perform buffering operations, respectively. As a person skilled in the art can understand the details of the digital-to-analog conversions and the buffering operations, further description is omitted here for brevity. In addition, the driving circuit 100 may utilize the pre-charging voltage generators 120-1 and 120-2 to output pre-charging voltages V_{L} and V_{H} for pre-charging, respectively. As shown in FIG. 1, each switch SW_{PC}(n,1) of the first set of switches {SW_{PC}(n1,1), SW_{PC}(n2,1), SW_{PC}(n3,1)} is arranged to selectively conduct the first pre-charging voltage generator 120-1 to a corresponding output terminal A(n) in the output terminals A(n1), A(n2), A(n3). Similarly, each switch SW_{PC}(n,2) of the first set of switches {SW_{PC}(n1,2), SW_{PC}(n2,2), SW_{PC}(n3,2)} is arranged to selectively conduct the first pre-charging voltage generator 120-2 to a corresponding output terminal A(n) in the output terminals A(n1), A(n2), A(n3).

In this embodiment, the switch control circuit 110 may control any switch within the first set of switches {SW_{PC}(n1,1), SW_{PC}(n2,1), SW_{PC}(n3,1)}, any switch within the second set of switches {SW_{PC}(n1,2), SW_{PC}(n2,2), SW_{PC}(n3,2)}, any switch within the another set of switches {SW_{CS}(n1), SW_{CS}(n2)} and any switch within the aforementioned switches {SW_{HZ}(n1), SW_{HZ}(n2), SW_{HZ}(n3) } to perform signal switching and also control switching time points as well as switching sequences in order to save time and/or reduce power consumption, especially power consumption in the buffers B(n1), B(n2), B(n3). For example, assuming that a symbol nₓ represents one of the indices n1, n2, n3, an output terminal A(nₓ) may represent one of the output terminals A(n1), A(n2), A(n3). Regarding any rising edge or falling edge control of a driving signal of the output terminal A(nₓ) (especially a switch control between two target voltage levels corresponding to different digital codes in the driving signal of the output terminal A(nₓ)), the switch control circuit 110 may perform signal switching by utilizing at least a portion of corresponding switches SW_{HZ}(nₓ), SW_{PC}(nₓ,1), SW_{PC}(nₓ,2) and SW_{CS}(nₓ) during at least one control phase (e.g. more than one control phase), thereby making the driving signal change from an original voltage level to a target voltage level efficiently and economically with the aid of at least one of pre-charging and charge-sharing. More particularly, the switch control circuit 110 may utilize the switch SW_{HZ}(n_{X}) to perform signal blocking, utilize at least one of the switches SW_{PC}(nₓ,1) and SW_{PC}(nₓ,2) to provide at least one of the pre-charging voltages V_{L} and V_{H} (which correspond to the pre-charging voltage generators 120-1 and 120-2, respectively) to a load capacitor C_{LOAD}(nₓ) for pre-charging, and utilize the switch SW_{CS}(nₓ) to perform chare-sharing between different sets of display cells. During the pre-charging or charge-sharing, the switch control circuit 110 may utilize the switch SW_{HZ}(nₓ) to cut the electrical connection between the buffer B(nₓ) and the load capacitor C_{LOAD}(nₓ), thereby suspending an operation performed upon the load capacitor C_{LOAD}(nₓ) by the buffer B(nₓ).

Please note that, according to variations of this embodiment, the number of the at least one pre-charging voltage generator may depend on design requirements of the driving circuit 100. For example, the number of the at least one pre-charging voltage generator may be changed to one to provide a single pre-charging voltage (e.g. a pre-charging voltage V_{M} between the pre-charging voltages V_{L} and V_{H}) for pre-charging. In another example, the number of the at least one pre-charging voltage generator may be changed to three or more than three, thus providing three or more than three pre-charging voltages for pre-charging.

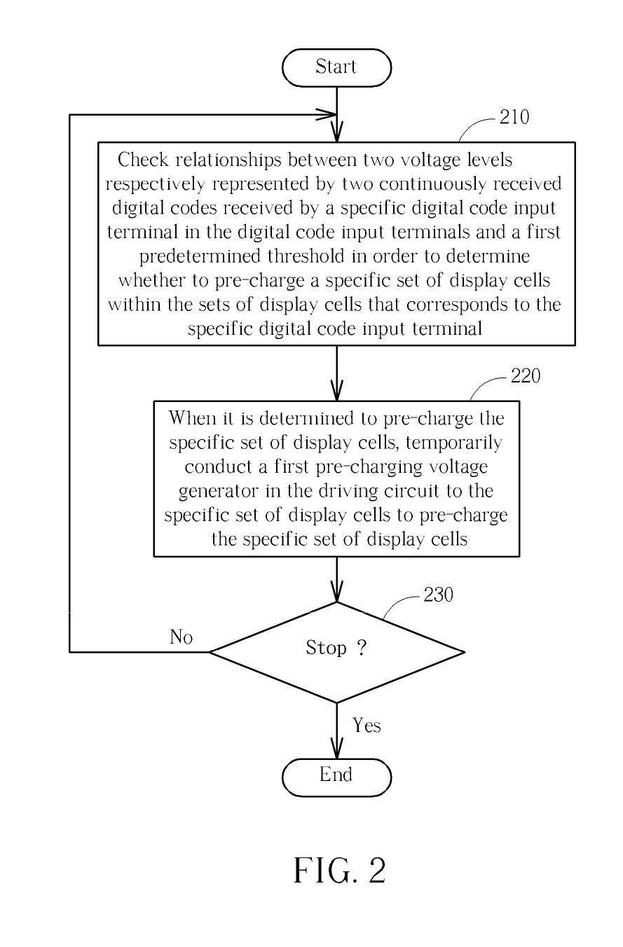

FIG. 2 is a flowchart illustrating an exemplary display driving method according to an embodiment of the present invention. The exemplary method may be employed in the driving circuit 100 shown in FIG. 1, especially the switch control circuit 110 shown in FIG. 1. The display driving method is described as below.

In step 210, the switch control circuit 110 may check relationships between two voltage levels respectively represented by two continuously received digital codes received by a specific digital code input terminal D(nₓ) (in the digital code input terminals D(n1), D(n2), D(n3)) and a predetermined threshold Th(1) in order to determine whether to pre-charge a specific set of display cells (especially the set of display cells represented by the load capacitor C_{LOAD}(nₓ)) within the sets of display cells that corresponds to the specific digital code input terminal D(nₓ), wherein the two voltage levels respectively represent voltage levels applied to the specific set of display cells by the driving circuit 100 at different time points according to indication of the two digital codes. For example, the predetermined threshold Th(1) may be equal to a voltage level of the pre-charging voltage V_{L}. In another example, a difference between the predetermined threshold Th(1) and the voltage level of the pre-charging voltage V_{L} may lie within a predetermined range, wherein the predetermined range, in practice, may represent a maximum tolerable shift which can avoid misjudgment occurring in step 210, or a predefined shift based on specific design requirements.

More particularly, in step 210, the switch control unit 210 may check whether the predetermined threshold Th(1) is between the two voltage levels. When it is checked that the predetermined threshold Th(1) is between the two voltage levels, the switch control circuit 110 may determine to pre-charge the specific set of display cells, especially the set of display cells represented by the load capacitor C_{LOAD}(nₓ).

In step 220, when it is determined to pre-charge the specific set of display cells, especially the set of display cells represented by the load capacitor C_{LOAD}(nₓ), the switch control circuit 110 may utilize a switch SW_{PC}(nₓ,1) (which corresponds to the specific digital code input terminal D(nₓ)) in the first set of switches {SW_{PC}(n1,1), SW_{PC}(n2,1), SW_{PC}(n3,1)} to temporarily conduct the pre-charging voltage generator 120-1 to the specific set of display cells for pre-charging the specific set of display cells.

In step 230, the switch control circuit 110 may check whether to stop a pre-charging function. For example, the driving circuit 100 may be designed to determine whether to temporarily enable or disable the pre-charging function according to a user setting. When it is detected that the pre-charging function should be stopped (e.g. the user setting indicates that the pre-charging function should be stopped), the flow shown in FIG. 2 is ended; otherwise, the flow returns to step 210.

In practice, the switch control circuit 110 may check a series of continuously received digital codes, and sequentially determine whether to pre-charge a rising edge or a falling edge between every two target voltage levels respectively represented by two adjacent and different digital codes in the series of continuously received digital codes. Assume that, when the flow enters a loop including steps 210 and 220 for the first time, the aforementioned two voltage levels include a first voltage level and a second voltage level, and the second voltage level represents a voltage level represented by a later received one of the two digital codes. For example, when the flow returns to step 210, two updated voltage levels under consideration in step 210 may include the second voltage level and a voltage level (e.g. a third voltage level) of next one digital code (following the two digital codes). In another example, when the flow returns to step 210, two updated voltage levels under consideration in step 210 may include two voltage levels (e.g. the third voltage level and a fourth voltage level) of next two digital codes (following the two digital codes).

Please note that, to facilitate understanding of technical features of the present invention, step 210 is described as checking the specific digital code input terminal D(nₓ), and step 220 is described as performing switch control of the switch SW_{PC}(nₓ,1) corresponding to the specific digital code input terminal D(nₓ). This is for illustrative purposes only, and is not meant to be a limitation of the present invention. According to variations of this embodiment, the switch control circuit 110 may check a plurality of specific digital code input terminals {D(nₓ)} in step 210, and perform switch control of a plurality of switches {SW_{PC}(nₓ,1)} respectively corresponding to the specific digital code input terminals {D(nₓ)} in step 220.

Additionally, the flow shown in FIG. 2 further includes step 230. However, this is for illustrative purposes only, and is not meant to be a limitation of the present invention. According to variations of this embodiment, step 230 may be omitted, and the flow may return to step 210 after completing step 220. According to variations of this embodiment, step 230 may be omitted, and when the flow returns to step 210, the predetermined threshold Th(1), the pre-charging voltage generator 120-1, and the first set of switches {SW_{PC}(n1,1), SW_{PC}(n2,1), SW_{PC}(n3,1)} may be replaced by a predetermined threshold Th(2), the pre-charging voltage generator 120-2, and the second set of switches {SW_{PC}(n1,2), SW_{PC}(n2,2), SW_{PC}(n3,2)}, wherein the predetermined threshold Th(2) is different from the predetermined threshold Th(1). For example, the predetermined threshold Th(2) may be equal to a voltage level of the pre-charging voltage V_{H}. In another example, a difference between the predetermined threshold Th(2) and the voltage level of the pre-charging voltage V_{H} may lie within a predetermined range (e.g. the aforementioned predetermined range).

According to variations of this embodiment, in step 210, the switch control circuit 110 may check whether the predetermined threshold Th(n1) is between the two voltage levels, and check whether the predetermined threshold Th(n2) is between the two voltage levels. When the predetermined threshold Th(n1) is between the two voltage levels and the predetermined threshold Th(n2) is between the two voltage levels, the switch control circuit 110 may determine to pre-charge the specific set of display cells, especially the set of display cells represented by the load capacitor C_{LOAD}(nₓ). In step 220, after the pre-charging voltage generator 120-1 is employed to pre-charge the specific set of display cells, the switch control circuit 110 may pre-charge the specific set of display cells by utilizing a switch SW_{PC}(nₓ,2) (which corresponds to the specific digital code input terminal D(nₓ)) in the second set of switches {SW_{PC}(n1,2), SW_{PC}(n2,2), SW_{PC}(n3,2)} to temporarily conduct the pre-charging voltage generator 120-2 to the specific set of display cells without conducting the pre-charging voltage generator 120-1 to the specific set of display cells, especially the set of display cells represented by the load capacitor C_{LOAD}(nₓ).

According to variations of this embodiment, in step 210, the switch control circuit 110 may check a relationship between at least one voltage level represented by at least one digital code in the two digital codes and a predetermined zone NAZ(1) to determine whether to pre-charge the specific set of display cells. More particularly, the switch control circuit 110 may check whether the predetermined threshold Th(1) is between the two voltage levels, and check whether at least one voltage level represented by at least one digital code in the two digital codes falls in the predetermined zone NAZ(1) to determine whether to pre-charge the specific set of display cells. For example, when it is determined that the predetermined threshold Th(1) is between the two voltage levels and both of the two voltage levels are beyond the predetermined zone NAZ(1), the switch control circuit 110 may determine to pre-charge the specific set of display cells (especially, the set of display cells represented by the load capacitor C_{LOAD}(nₓ)), wherein the predetermined zone NAZ(1) may be regarded as a no action zone. According to one of the variations, the predetermined zone NAZ(1) may include the predetermined threshold Th(1). For example, the predetermined zone NAZ(1) may be defined as [Th(1)−DELTA, Th(1)+DELTA], where DELTA is a positive value or 0, and the predetermined threshold Th(1) is equal to a central value of the predetermined zone NAZ(1). This is for illustrative purposes only, and is not meant to be a limitation of the present invention. According to another one of the variations, the predetermined zone NAZ(1) may be immediately adjacent to the predetermined threshold Th(1). For example, the predetermined threshold Th(1) may be defined as (Th(1), Th(1)+DELTA′], where DELTA′ is a positive value. In another example, the predetermined zone NAZ(1) may be defined as [Th(1)−DELTA″, Th(1)), where DELTA″ is a positive value.

Similarly, according to variations of this embodiment, the switch control circuit 110 may check a relationship between at least one voltage level represented by at least one digital code in the two digital codes and a predetermined zone NAZ(2) to determine whether to pre-charge the specific set of display cells in step 210. More particularly, the switch control circuit 110 may check whether the predetermined threshold Th(2) is between the two voltage levels and check whether at least one voltage level represented by at least one digital code in the two digital codes falls in the predetermined zone NAZ(2), to determine whether to pre-charge the specific set of display cells. For example, when it is determined that the predetermined threshold Th(2) is between the two voltage levels and both of the two voltage levels are beyond the predetermined zone NAZ(2), the switch control circuit 110 may determine to pre-charge the specific set of display cells (especially, the set of display cells represented by the load capacitor C_{LOAD}(nₓ)), wherein the predetermined zone NAZ(2) may be regarded as a no action zone. According to one of the variations, the predetermined zone NAZ(2) may include the predetermined threshold Th(2). For example, the predetermined zone NAZ(2) may be defined as [Th(2)−DELTA, Th(2)+DELTA], where DELTA is a positive value, and the predetermined threshold Th(2) is equal to a central value of the predetermined zone NAZ(2). This is for illustrative purposes only, and is not meant to be a limitation of the present invention. According to another one of the variations, the predetermined zone NAZ(2) may be immediately adjacent to the predetermined threshold Th(2). For example, the predetermined threshold Th(2) may be defined as (Th(2), Th(2)+DELTA′], where DELTA′ is a positive value. In another example, the predetermined zone NAZ(2) may be defined as [Th(2)−DELTA″, Th(2)), where DELTA″ is a positive value.

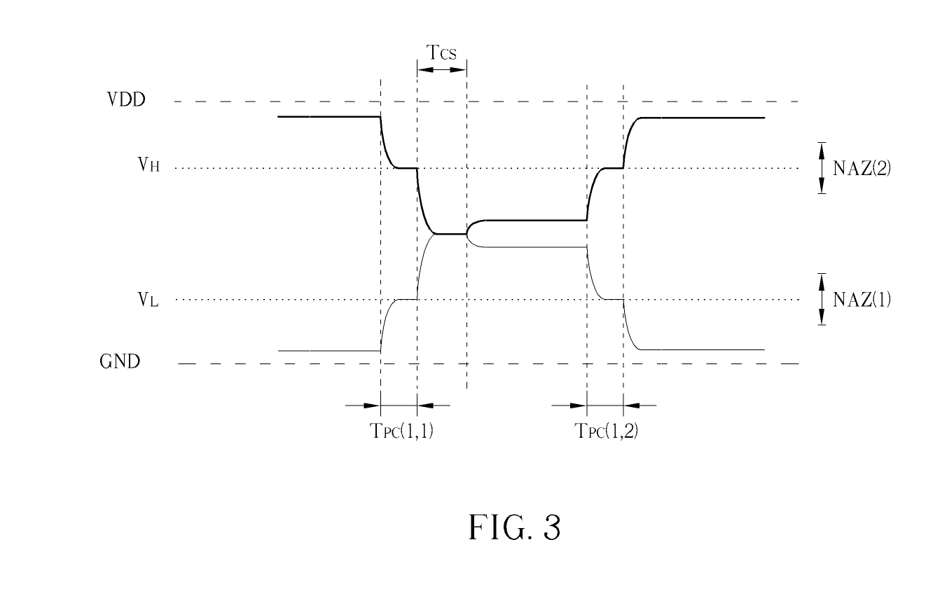

FIG. 3 illustrates a timing diagram involved in the display driving method shown in FIG. 2 according to an embodiment of the present invention. In a series of embodiments starting from this embodiment, a symbol “VDD” may stand for a possible highest driving level of driving signals outputted from the output terminals A(n1), A(n2), A(n3), and a symbol “GND” may stand for a possible lowest driving level (e.g. ground level) of the driving signals outputted from the output terminals A(n1), A(n2), A(n3). This is for illustrative purposes only, and is not meant to be a limitation of the present invention. In variations of the series of embodiments where the possible lowest driving level of the driving signals outputted from the output terminals A(n1), A(n2), A(n3) is not the ground level, the commonly-used symbol “GND” of the ground level may be replaced by another symbol in respective timing diagrams of these variations. To facilitate the description of the series of embodiments, in each of timing diagrams thereof, a signal having a higher initial voltage level (i.e. a signal starting from the top left corner in the timing diagram) may be referred to as a driving signal Sₓ, and a signal having a lower initial voltage level (i.e. a signal starting from the bottom left corner in the timing diagram) may be referred to as a driving signal S_{y}, wherein the driving signals Sₓ and S_{y} are outputted from output terminals A(nₓ) and A(n_{y}) of the output terminals A(n1), A(n2), A(n3), respectively. This is for illustrative purposes only, and is not meant to be a limitation of the present invention. In different embodiments of the series of embodiments, the corresponding driving signal Sₓ is not necessarily a driving signal outputted from the same output terminal of the output terminals A(n1), A(n2), A(n3), and the corresponding driving signal S_{y} is not necessarily a driving signal outputted from the same output terminal of the output terminals A(n1), A(n2), A(n3). Additionally, in the series of embodiments and variations thereof, time intervals, such as time intervals {T_{CS}} and {T_{PS}}, may be used as an example of the aforementioned at least one control phase.

As shown in FIG. 3, during a time interval T_{PC}(1,1), the switch control circuit 110 utilizes the switches SW_{PC}(nₓ,2) and SW_{PC}(n_{y},1) to temporarily conduct the pre-charging voltages V_{H} and V_{L} to the output terminals A(nₓ) and A(n_{y}), respectively, for pre-charging. During a time interval T_{CS}, the switch control circuit 110 utilizes a switch between the output terminals A(nₓ) and A(n_{y}) (e.g. the switch SW_{CS}(nₓ)) to temporarily conduct the output terminals A(nₓ) and A(n_{y}) to each other for charge-sharing. Next, the driving circuit 100 may drive the driving signals Sₓ and S_{y} to the corresponding target voltage levels in a middle control phase by temporarily utilizing the buffers B(nₓ) and B(n_{y}) to perform buffering operations, respectively. During a time interval T_{PC}(1,2), the switch control circuit 110 utilizes the switches SW_{PC}(nₓ,2) and SW_{PC}(n_{y},1) to temporarily conduct the pre-charging voltages V_{H} and V_{L} to the output terminals A(nₓ) and A(n_{y}), respectively, for pre-charging. Next, the driving circuit 100 may drive the driving signals Sₓ and S_{y} to the corresponding target voltage levels in a rightmost control phase by temporarily utilizing the buffers B(nₓ) and B(n_{y}) to perform buffering operations, respectively.

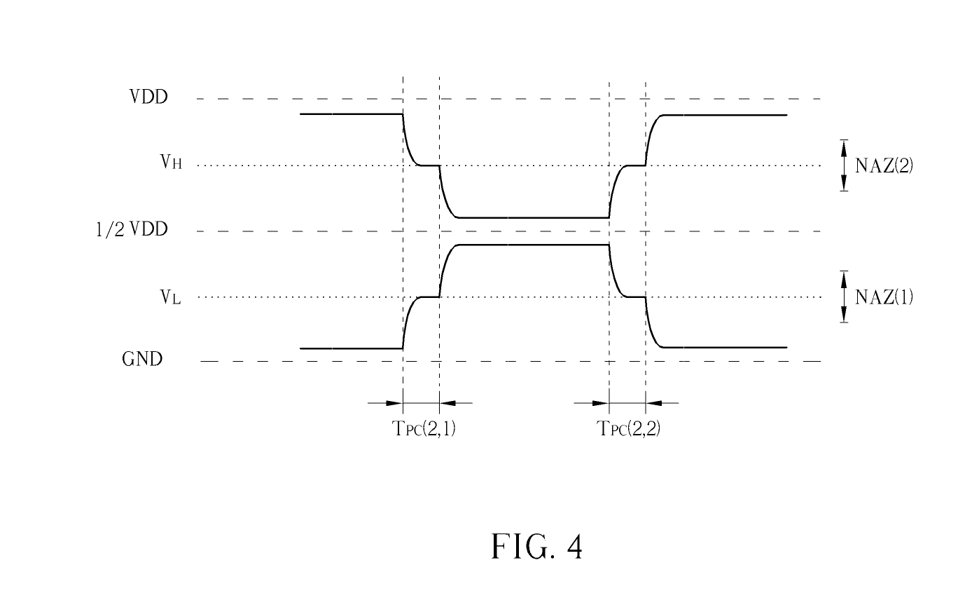

FIG. 4 illustrates a timing diagram involved in the display driving method shown in FIG. 2 according to another embodiment of the present invention. During a time interval T_{PC} (2,1), the switch control circuit 110 utilizes the switches SW_{PC}(nₓ,2) and SW_{PC}(n_{y},1) to temporarily conduct the pre-charging voltages V_{H} and V_{L} to the output terminals A(nₓ) and A(n_{y}), respectively, for pre-charging. Next, the driving circuit 100 may drive the driving signals Sₓ and S_{y} to the corresponding target voltage levels in a middle control phase by temporarily utilizing the buffers B(nₓ) and B(n_{y}) to perform buffering operations, respectively. During a time interval T_{PC}(2,2), the switch control circuit 110 utilizes the switches SW_{PC}(nₓ,2) and SW_{PC}(n_{y},1) to temporarily conduct the pre-charging voltages V_{H} and V_{L} to the output terminals A(nₓ) and A(n), respectively, for pre-charging. Next, the driving circuit 100 may drive the driving signals Sₓ and S_{y} to the corresponding target voltage levels in a rightmost control phase by temporarily utilizing the buffers B(nₓ) and B(n_{y}) to perform buffering operations, respectively.

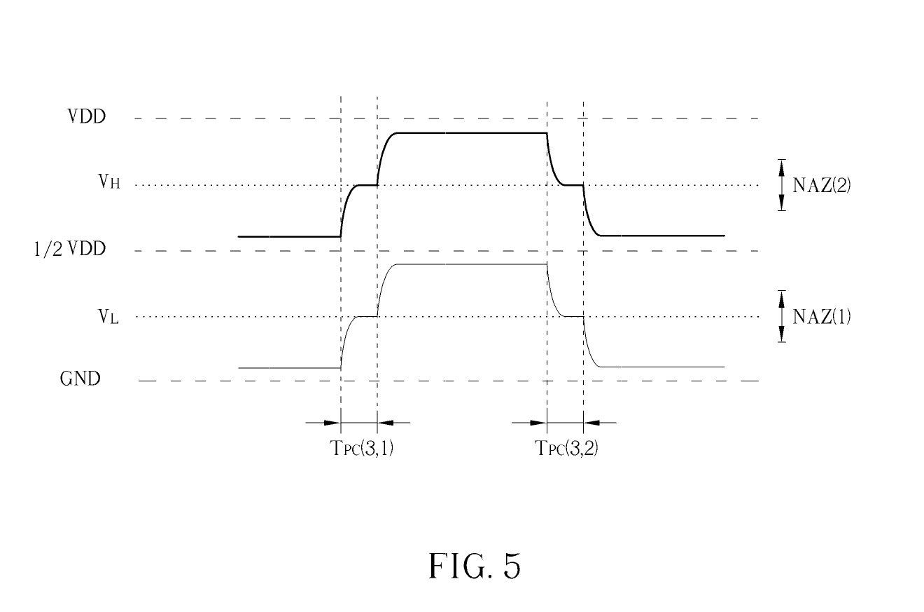

FIG. 5 illustrates a timing diagram involved in the display driving method shown in FIG. 2 according to another embodiment of the present invention. During a time interval T_{PC}(3,1), the switch control circuit 110 utilizes the switches SW_{PC}(nₓ,2) and SW_{PC}(n_{y},1) to temporarily conduct the pre-charging voltages V_{H} and V_{L} to the output terminals A(nₓ) and A(n_{y}), respectively, for pre-charging. Next, the driving circuit 100 may drive the driving signals Sₓ and S_{y} to the corresponding target voltage levels in a middle control phase by temporarily utilizing the buffers B(nₓ) and B(n_{y}) to perform buffering operations, respectively. During a time interval T_{PC}(3,2), the switch control circuit 110 utilizes the switches SW_{PC}(nₓ,2) and SW_{PC}(n_{y},1) to temporarily conduct the pre-charging voltages V_{H} and V_{L} to the output terminals A(nₓ) and A(n_{y}), respectively, for pre-charging. Next, the driving circuit 100 may drive the driving signals Sₓ and S_{y} to corresponding target voltage levels in a rightmost control phase by temporarily utilizing the buffers B(nₓ) and B(n_{y}) to perform buffering operations, respectively.

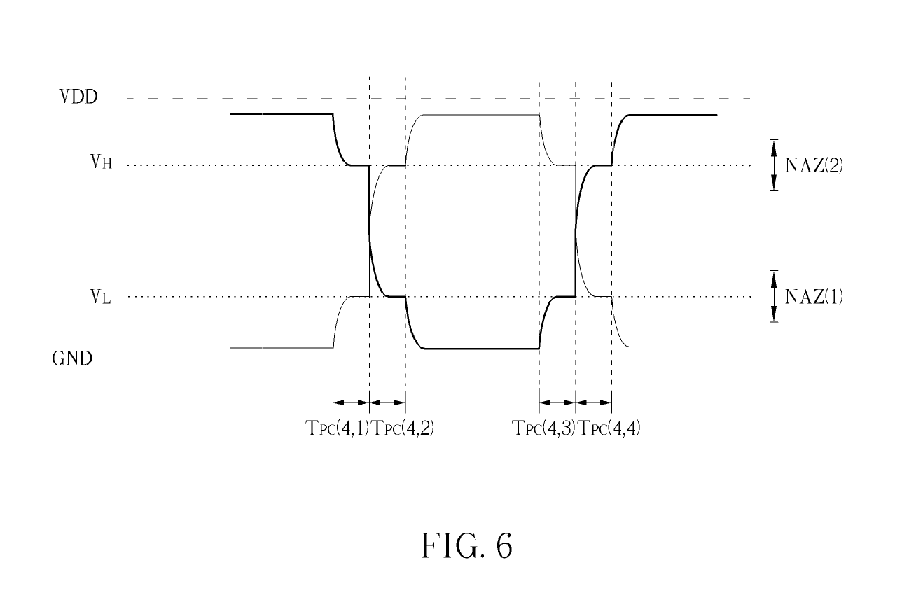

FIG. 6 illustrates a timing diagram involved in the display driving method shown in FIG. 2 according to another embodiment of the present invention. During a time interval T_{PC}(4,1), the switch control circuit 110 utilizes the switches SW_{PC}(nₓ,2) and SW_{PC}(n_{y},1) to temporarily conduct the pre-charging voltages V_{H} and V_{L} to the output terminals A(nₓ) and A(n_{y}), respectively, for pre-charging. During a time interval T_{PC}(4,2), the switch control circuit 110 utilizes the switches SW_{PC}(nₓ,1) and SW_{PC}(n_{y},2) to temporarily conduct the pre-charging voltages V_{L} and V_{H} to the output terminals A(nₓ) and A(n_{y}), respectively, for pre-charging. Next, the driving circuit 100 may drive the driving signals Sₓ and S_{y} to the corresponding target voltage levels in a middle control phase by temporarily utilizing the buffers B(nₓ) and B(n_{y}) to perform buffering operations, respectively. During a time interval T_{PC}(4,3), the switch control circuit 110 utilizes the switches SW_{PC}(nₓ,1) and SW_{PC}(n_{y},2) to temporarily conduct the pre-charging voltages V_{L} and V_{H} to the output terminals A(nₓ) and A(n_{y}), respectively, for pre-charging. During a time interval T_{PC}(4,4), the switch control circuit 110 utilizes the switches SW_{PC}(nₓ,2) and SW_{PC}(n_{y},1) to temporarily conduct the pre-charging voltages V_{H} and V_{L} to the output terminals A(nₓ) and A(n_{y}), respectively, for pre-charging. Next, the driving circuit 100 may drive the driving signals Sₓ and S_{y} to corresponding target voltage levels in a rightmost control phase by temporarily utilizing the buffers B(nₓ) and B(n_{y}) to perform buffering operations, respectively.

Please note that, as no charge-sharing operation (e.g. the charge-sharing operation during the time interval T_{CS} shown in FIG. 3) is performed in this embodiment, a higher signal driving speed can be achieved by limiting a total number of control phases to no more than three, more particularly by avoiding the use of the control phase corresponding to the time interval T_{CS}.

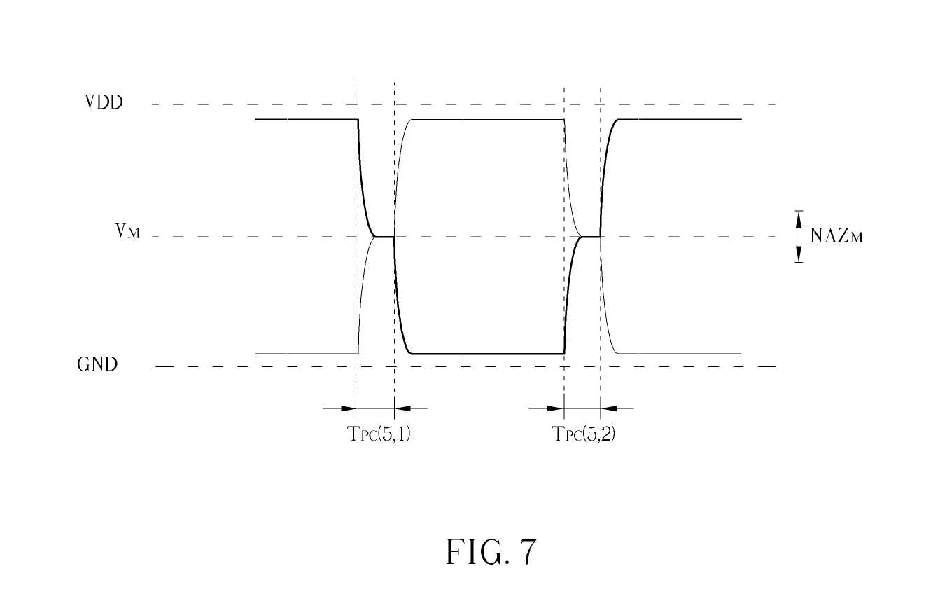

FIG. 7 illustrates a timing diagram involved in the display driving method shown in FIG. 2 according to another embodiment of the present invention, wherein the pre-charging voltages V_{H} and V_{L} are simplified as a single pre-charging voltage such as a pre-charging voltage V_{M}, and the predetermined zones NAZ(2) and NAZ(1) are simplified as a corresponding predetermined zone NAZ_{M}. In this case, the switches SW_{PC}(nₓ,2) and SWₚc(nₓ,1) may be simplified as the same switch SW_{PC}(nₓ), and the switches SW_{PC}(n_{y},2) and SW_{PC}(n_{y},1) may be simplified as the same switch SW_{PC}(n_{y}).

As shown in FIG. 7, during a time interval T_{PC}(5,1), the switch control circuit 110 utilizes the switches SW_{PC}(nₓ) and SWₚc(n_{y}) to temporarily conduct the pre-charging voltage V_{M}to the output terminals A(nₓ) and A(n_{y}), respectively, for pre-charging. Next, the driving circuit 100 may drive the driving signals Sₓ and S_{y} to the corresponding target voltage levels in a middle control phase by temporarily utilizing the buffers B(nₓ) and B(n_{y}) to perform buffering operations, respectively. During a time interval T_{PC}(5,2), the switch control circuit 110 utilizes the switches SW_{PC}(nₓ) and SWₚc(n_{y}) to temporarily conduct the pre-charging voltages V_{M}to the output terminals A(nₓ) and A(n_{y}), respectively, for pre-charging. Next, the driving circuit 100 may drive the driving signals Sₓ and S_{y} to the corresponding target voltage levels in a rightmost control phase by temporarily utilizing the buffers B(nₓ) and B(n_{y}) to perform buffering operations, respectively.

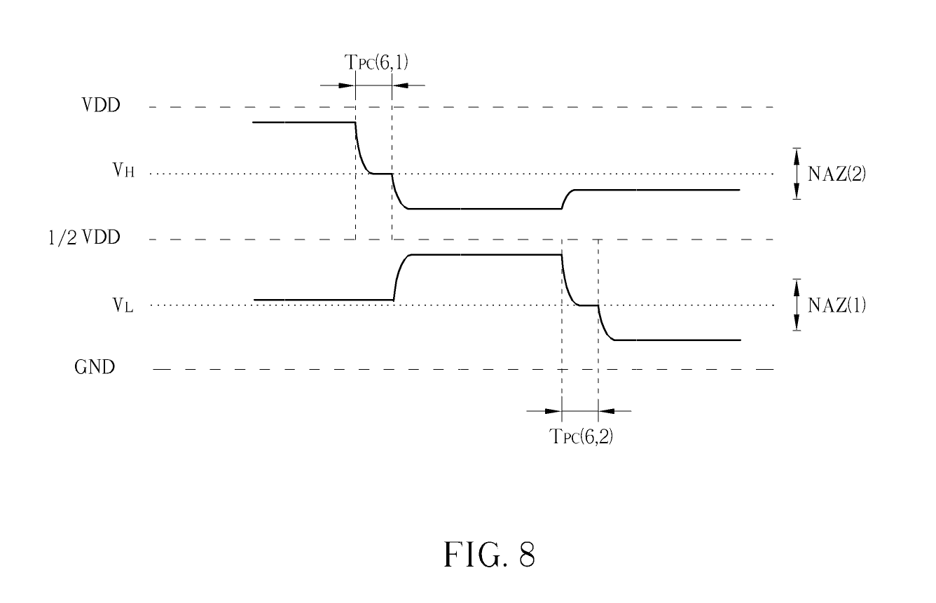

FIG. 8 illustrates a timing diagram involved in the display driving method shown in FIG. 2 according to another embodiment of the present invention. During a time interval T_{PC}(6,1), the switch control circuit 110 utilizes the switch SW_{PC}(nₓ,2) to temporarily conduct the pre-charging voltage V_{H} to the output terminal A(nₓ) for pre-charging. As the driving signal S_{y} does not meet a pre-charging activation criterion, the switch control circuit 110 does not activate a pre-charging operation for the driving signal S_{y}. For example, as the switch control circuit 110 detects that an initial voltage level of the driving signal S_{y} falls in the predetermined zone NAZ(1), it is determined that the driving signal S_{y} does not meet the pre-charging activation criterion. In another example, as the switch control circuit 110 detects that the predetermined threshold Th(1) is not between an initial voltage level of the driving signal S_{y} and an expected target voltage level of a middle control phase of the driving signal S_{y}, it is determined that the driving signal S_{y} does not meet the pre-charging activation criterion.

After the time interval T_{PC}(6,1), the driving circuit 100 may drive the driving signals Sₓ and S_{y} to the corresponding target voltage levels in a middle control phase by temporarily utilizing the buffers B(nₓ) and B(n_{y}) to perform buffering operations, respectively. During a time interval T_{PC}(6,2), the switch control circuit 110 utilizes the switch SW_{PC}(n_{y},1) to temporarily conduct the pre-charging voltage V_{L} to the output terminals and A(n_{y}) for pre-charging. As the driving signal Sₓ does not meet a pre-charging activation criterion, the switch control circuit 110 does not activate a pre-charging operation for the driving signal Sₓ. For example, as the switch control circuit 110 detects that an initial voltage level of the driving signal Sₓ falls in the predetermined zone NAZ(2), it is determined that the driving signal Sₓ does not meet the pre-charging activation criterion. In another example, as the switch control circuit 110 detects that the predetermined threshold Th(2) is not between an initial voltage level of the driving signal Sₓ and an expected target voltage level of a middle control phase of the driving signal Sₓ, it is determined that the driving signal Sₓ does not meet the pre-charging activation criterion.

As shown in FIG. 8, the driving circuit 100 may drive the driving signal Sₓ to a corresponding target voltage level of a rightmost control phase by temporarily utilizing the buffer B(nₓ) to perform a buffering operation. After the time interval T_{PC}(6,2), the driving circuit 100 may drive the driving signal S_{y} to a corresponding target voltage level of the rightmost control phase by temporarily utilizing the buffer B(n_{y}) to perform a buffering operation.

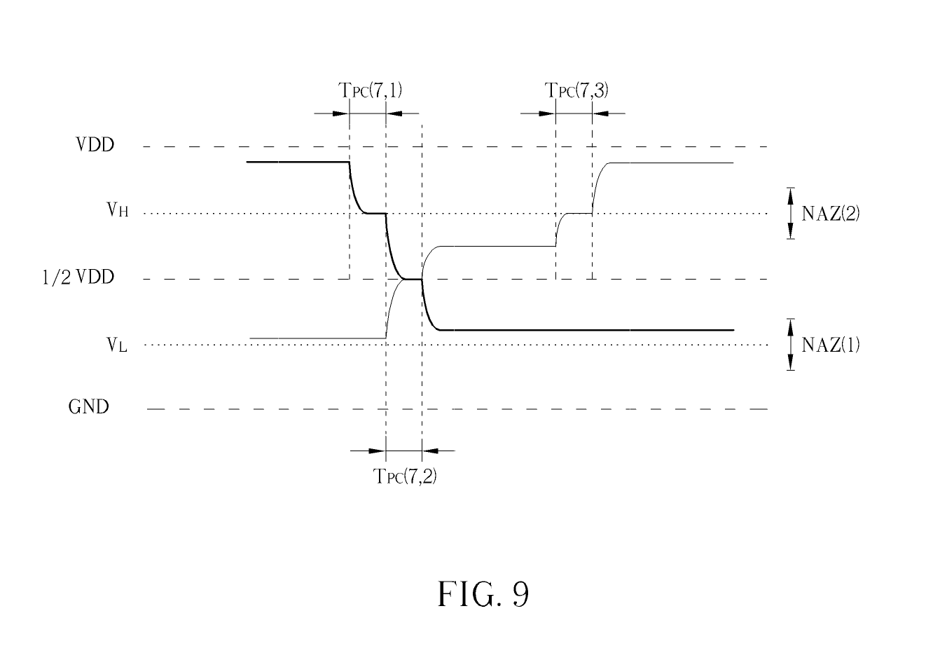

FIG. 9 illustrates a timing diagram involved in the display driving method shown in FIG. 2 according to another embodiment of the present invention. Besides the pre-charging voltage generators 120-1 and 120-2, the driving circuit 100 further includes a pre-charging voltage generator 120-M in order to provide another pre-charging voltage such as the pre-charging voltage V_{M}. For example, the pre-charging voltage V_{M} in this embodiment may be equal to (½)*VDD. Additionally, as the pre-charging voltages V_{H} and V_{L} are now extended to three pre-charging voltages V_{M}, V_{H} and V_{L}, the switches SW_{PC}(nₓ,2) and SW_{PC}(nₓ,1) may be extended to three switches SW_{PC}(nₓ,M), SW_{PC}(nₓ,2) and SW_{PC}(nₓ,1), and the switches SW_{PC}(n_{y},2) and SW_{PC}(n_{y},1) may be extended to three switches SW_{PC}(n_{y},M), SW_{PC}(n_{y},2) and SW_{PC}(n_{y},1).

During a time interval T_{PC}(7,1), the switch control circuit 110 utilizes the switch SW_{PC}(nₓ,2) to temporarily conduct the pre-charging voltage V_{H} to the output terminals and A(nₓ) for pre-charging. As the driving signal S_{y} does not meet a pre-charging activation criterion, the switch control circuit 110 does not activate a pre-charging operation for the driving signal S_{y}. During a time interval T_{PC}(7,2), the switch control circuit 110 utilizes the switches SW_{PC}(nₓ,M) and SW_{PC}(n_{y},M) to temporarily conduct the pre-charging voltage V_{M} to the output terminals and A(nₓ) and A(n_{y}) for pre-charging, respectively. Next, the driving circuit 100 may drive the driving signals Sₓ and S_{y} to the corresponding target voltage levels of a middle control phase by temporarily utilizing the buffers B(nₓ) and B(n_{y}) to perform buffering operations, respectively.

As shown in FIG. 9, as an expected voltage level of the rightmost control phase of the driving signal Sₓ is equal to a voltage level of the middle control phase of the driving signal Sₓ, the buffering operation of the buffer B(nₓ) utilized by the driving circuit 100 may last to the rightmost control phase. In addition, during a time interval T_{PC}(7,3), the switch control circuit 110 utilizes the switch SW_{PC}(n_{y},2) to temporarily conduct the pre-charging voltage V_{H} to the output terminal A(n_{y}) for pre-charging. As the driving signal Sₓ does not meet a pre-charging activation criterion, the switch control circuit 110 does not activate a pre-charging operation for the driving signal Sₓ. Next, the driving circuit 100 may drive the driving signal S_{y} to a corresponding target voltage level of the rightmost control phase by temporarily utilizing the buffer B(n_{y}) to perform a buffering operation.

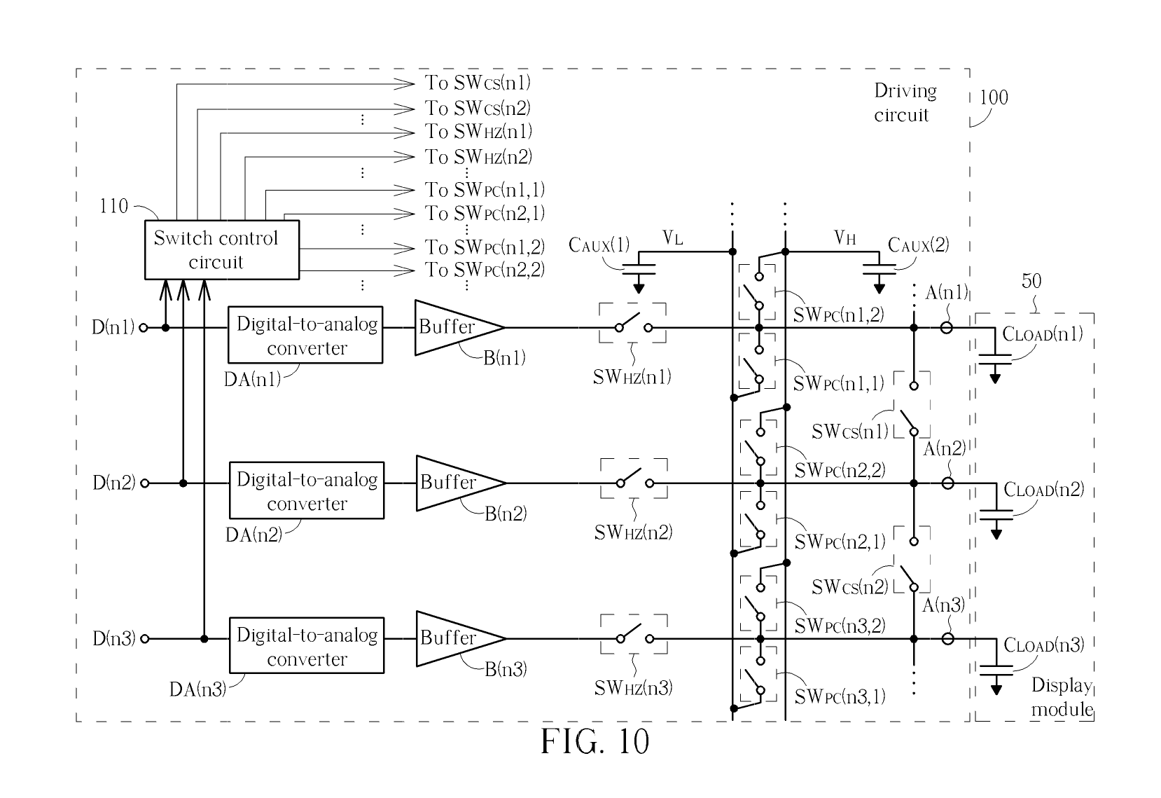

FIG. 10 is a diagram illustrating an exemplary driving circuit of a display apparatus according to a second embodiment of the present invention. Compared to the first embodiment, the aforementioned pre-charging voltage generators 120-1 and 120-2 may be implemented by a plurality of capacitors C_{AUX}(1) and C_{AUX}(2) in this embodiment, respectively. The capacitors C_{AUX}(1) and C_{AUX}(2) may also be referred to as auxiliary capacitors. In practice, the capacitors C_{AUX}(1) and C_{AUX}(2) are not required to be coupled to any voltage source.

According to this embodiment, the capacitors C_{Aux}(1) and C_{Aux}(2) may be unable to accurately provide the pre-charging voltages V_{H} and V_{L}, respectively, during a short period of time immediately after the activation of the driving circuit 100. However, based on implementation experiences and theoretical analyses, the capacitors C_{AUX}(1) and C_{AUX}(2) will enter a steady state while respective voltage levels of non-ground terminals of the capacitors C_{AUX}(1) and C_{AUX}(2) are automatically approaching the corresponding pre-charging voltages V_{L} and V_{H}. After entering the steady state, the capacitors C_{AUX}(1) and C_{AUX}(2) thus provide the pre-charging voltages V_{L} and V_{H} accordingly. For example, assuming that the first predetermined threshold and the second predetermined threshold are set as ((⅓)*VDD) and ((⅔)*VDD), respectively, the pre-charging voltages V_{L} and V_{H} may be ((⅓)*VDD) and ((⅔)*VDD), respectively, in the aforementioned steady state. The similarity between this embodiment and the first embodiment (or variations thereof) is not detailed here for brevity.

It is an advantage of the present invention that, compared to a conventional driving circuit, the proposed display driving method and an associated driving circuit can mitigate the aforementioned side effects and further enhance overall efficiency of the driving circuit. More particularly, regarding any rising edge or falling edge control of all driving signals except for the embodiment shown in FIG. 9, only three control phases are needed at most.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A display driving method applied to a driving circuit of a display apparatus, the driving circuit comprising a plurality of digital code input terminals corresponding to a plurality of sets of display cells of the display, a digital code received by each digital code input terminal representing a predetermined gray-level of a corresponding set of display cells within the sets of display cells, the display driving method comprising:
checking relationships between two voltage levels respectively represented by two continuously received digital codes received by a specific digital code input terminal and a first predetermined threshold in order to determine whether to pre-charge a specific set of display cells within the sets of display cells that corresponds to the specific digital code input terminal, wherein the two voltage levels respectively represent voltage levels applied to the specific set of display cells by the driving circuit at different time points according to indication of the two digital codes; and
when it is determined to pre-charge the specific set of display cells, temporarily conducting a first pre-charging voltage generator in the driving circuit to the specific set of display cells to pre-charge the specific set of display cells, wherein the first pre-charging voltage generator is arranged for outputting a first pre-charging voltage for pre-charging.

2. The display driving method of claim 1, wherein the step of checking the relationships between the two voltage levels and the first predetermined threshold to determine whether to pre-charge the specific set of display cells comprises:
checking a relationship between at least one voltage level represented by at least one digital code in the two digital codes and a first predetermined zone to determine whether to pre-charge the specific set of display cells, wherein the first predetermined zone is immediately adjacent to the first predetermined threshold, or the first predetermined zone has the first predetermined threshold included therein.

3. The display driving method of claim 2, wherein the first predetermined threshold is equal to a central value of the first predetermined zone.

4. The display driving method of claim 2, wherein the step of checking the relationships between the two voltage levels and the first predetermined threshold to determine whether to pre-charge the specific set of display cells further comprises:
checking whether at least one voltage level represented by at least one digital code in the two digital codes falls in the first predetermined zone to determine whether to pre-charge the specific set of display cells.

5. The display driving method of claim 4, wherein the step of checking the relationships between the two voltage levels and the first predetermined threshold to determine whether to pre-charge the specific set of display cells further comprises:
checking whether the first predetermined threshold is between the two voltage levels; and
when the first predetermined threshold is between the two voltage levels and the two voltage levels are both beyond the first predetermined zone, determining to pre-charge the specific set of display cells.

6. The display driving method of claim 1, wherein the step of checking the relationships between the two voltage levels and the first predetermined threshold to determine whether to pre-charge the specific set of display cells further comprises:
checking whether the first predetermined threshold is between the two voltage levels; and
when the first predetermined threshold is between the two voltage levels, determining to pre-charge the specific set of display cells.

7. The display driving method of claim 1, wherein the step of checking the relationships between the two voltage levels and the first predetermined threshold to determine whether to pre-charge the specific set of display cells further comprises:
checking whether the first predetermined threshold is between the two voltage levels, and checking whether a second predetermined threshold is between the two voltage levels, wherein the second predetermined threshold is different from the first predetermined threshold; and
when the first predetermined threshold is between the two voltage levels and the second predetermined threshold is between the two voltage levels, determining to pre-charge the specific set of display cells;
wherein the display driving method further comprises:
after employing the first predetermined pre-charging voltage generator to pre-charge the specific set of display cells, pre-charging the specific set of display cells by temporarily conducting a second pre-charging voltage generator to the specific set of display cells without conducting the first pre-charging voltage generator to the specific set of display cells, wherein the second pre-charging voltage generator is arranged for outputting a second pre-charging voltage for pre-charging.

8. The display driving method of claim 7, wherein the first pre-determined threshold value is equal to a voltage level of the first pre-charging voltage, and the second pre-determined threshold value is equal to a voltage level of the second pre-charging voltage.

9. The display driving method of claim 1, wherein the first pre-charging generator comprises at least a portion of a power management circuit.

10. The display driving method of claim 1, wherein the first pre-charging voltage generator comprises a capacitor.

11. A driving circuit of a display apparatus, comprising:
a plurality of driving modules, arranged for driving a plurality of sets of display cells of the display apparatus, wherein the driving modules comprise a plurality of digital code input terminals and a plurality of output terminals, the output terminals are electrically connected to the sets of display cells, the digital code input terminals correspond to the sets of display cells, respectively, and a digital code received by each digital code input terminal represents a predetermined gray-level of a corresponding set of display cells within the sets of display cells;
a first pre-charging voltage generator, arranged for outputting a first pre-charging voltage for pre-charging;
a first set of switches, electrically connected between the first pre-charging voltage generator and the output terminals, respectively, to perform signal switching, wherein each switch in the first set of switches is utilized to selectively conduct the first pre-charging voltage generator to a corresponding output terminal in the output terminals; and
a switch control circuit, coupled to the digital code input terminals and electrically connected to the first set of switches, the switch control circuit arranged for checking relationships between two voltage levels respectively represented by two continuously received digital codes received by a specific digital code input terminal and a first predetermined threshold to determine whether to pre-charge a specific set of display cells within the sets of display cells that corresponds to the specific digital code input terminal, wherein the two voltage levels respectively represent voltage levels applied to the specific set of display cells by the driving circuit at different time points according to indication of the two digital codes;
wherein when it is determined to pre-charge the specific set of display cells, the switch control circuit utilizes a switch corresponding to the specific digital code input terminal in the first set of switches to temporarily conduct the first pre-charging voltage generator to the specific set of display cells to pre-charge the specific set of display cells.

12. The driving circuit of claim 11, wherein the switch control circuit checks a relationship between at least one voltage level represented by at least one digital code in the two digital codes and a first predetermined zone to determine whether to pre-charge the specific set of display cells, where the first predetermined zone is immediately adjacent to the first predetermined threshold, or the first predetermined zone has the first predetermined threshold included therein.

13. The driving circuit of claim 12, wherein the first predetermined threshold is equal to a central value of the first predetermined zone.

14. The driving circuit of claim 12, wherein the switch control circuit checks whether at least one voltage level represented by at least one digital code in the two digital codes falls in the first predetermined zone to determine whether to pre-charge the specific set of display cells.

15. The driving circuit of claim 14, wherein the switch control circuit checks whether the first predetermined threshold is between the two voltage levels; and when the first predetermined threshold is between the two voltage levels and the two voltage levels are both beyond the first predetermined zone, the switch control circuit determines to pre-charge the specific set of display cells.

16. The driving circuit of claim 11, wherein the switch control circuit checks whether the first predetermined threshold is between the two voltage levels; and when the first predetermined threshold is between the two voltage levels, the switch control circuit determines to pre-charge the specific set of display cells.

17. The driving circuit of claim 11, further comprising:
a second pre-charging voltage generator, arranged for outputting a second pre-charging voltage for pre-charging; and
a second set of switches, electrically connected between the second pre-charging voltage generator and the output terminals, respectively, to perform signal switching, wherein each switch in the second set of switches is utilized to selectively conduct the second pre-charging voltage generator to a corresponding output terminal in the output terminals, and the second set of switches is electrically connected to the switch control circuit;
wherein the switch control circuit checks whether the first predetermined threshold is between the two voltage levels, and checks whether a second predetermined threshold is between the two voltage levels, where the second predetermined threshold is different from the first predetermined threshold; when the first predetermined threshold is between the two voltage levels and the second predetermined threshold is between the two voltage levels, the switch control circuit determines to pre-charge the specific set of display cells; and after employing the first predetermined pre-charging voltage generator to pre-charge the specific set of display cells, the switch control circuit pre-charges the specific set of display cells by utilizing a switch in the second set of switches that corresponds to the specific digital code input terminal to temporarily conduct the second pre-charging voltage generator to the specific set of display cells without conducting the first pre-charging voltage generator to the specific set of display cells.

18. The driving circuit of claim 17, wherein the first pre-determined threshold value is equal to a voltage level of the first pre-charging voltage, and the second pre-determined threshold value is equal to a voltage level of the second pre-charging voltage.

19. The driving circuit of claim 11, wherein the first pre-charging generator comprises at least a portion of a power management circuit.

20. The driving circuit of claim 11, wherein the first pre-charging voltage generator comprises a capacitor.
